(19) United States
(12) Patent Application Publication
(10) Pub. No.: US 2003/0014481 A1
(43) Pub. Date: Jan. 16, 2003

(54) Management system and method for sharing operating information

(75) Inventors: Nobuaki Tsuge, Shonan-machi (JP); Toshio Hirosawa, Machida (JP); Kazunari Takenoshita, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/062,846

(22) Filed: Jan. 31, 2002

(30) Foreign Application Priority Data
Jul. 13, 2001 (JP) 2001-213032

(51) Int. Cl. G06F 15/16

(52) U.S. Cl. 709/203

(57) ABSTRACT

An outsourcing system provides a cooperative work environment beneficial for an outsourcing agent to carry out monitoring and surrogate operation of customer systems in cooperation with the customers. A site unit is provided for each of the customers and a center monitoring unit is provided for the outsourcing agent, so that not only the center monitoring unit but also the customers and system engineers are notified of obstacle occurrence. There is provided an environment in which such participants can refer, at any time via the Internet, to operating information files, design and construction information files, discussion history files, stored up to the point of time when the reference is made. The participants can share operation states and design information stored up to the point of time of the obstacle occurrence, and cooperate with one another to advance work for problem solution. Accordingly, a new service architecture can be developed.

### BACKGROUND OF THE INVENTION

The present invention relates to a technique for providing cooperative outsourcing service by use of accumulated monitoring information and operating information in a network system and a server operation center system. Particularly, it relates to a system in which operating information and design information are shared among a monitor operator, designers and customers in outsourcing service for operation monitoring to thereby achieve an outsourcing service architecture.

With the wide spread of the network infrastructure in companies in recent years, large-scale computer systems, servers such as groups of workstations and personal computers are connected to one another on the basis of a network system so as to execute various kinds of service. Along with this tendency, a network system becomes the base for information infrastructure and the network system is required to be monitored continuously 24 hours a day, everyday. The network system is generally monitored in such a manner that monitoring apparatus monitors apparatus such as servers, routers, and so on, in the network system on the basis of simple network management protocol SNMP (RFC 1157) defined in the request for comments (RFC).

The monitoring apparatus based on the SNMP displays, on a monitor screen, the content of a medial information base MIB for obstacle information added to obstacle notification interrupt Trap from the network system, and stores the content in a file unit as obstacle history information.

A monitoring person in the network watches the obstacle monitoring information and data for monitoring performance such as CPU utilization rates of the servers displayed on the monitor screen of the monitoring apparatus having a monitoring function. Thus, the monitoring person judges obstacle places in the network system and the server systems, and monitors the performance. Also when the monitoring person monitors the network system based on the SNMP as a whole, the monitoring person integrates a group of monitoring apparatus distributed geographically so as to monitor the operation state.

JP-06242991 discloses a method for performing remote monitoring of a computer system. In this method, a signal from a service processor SVP due to a obstacle of the computer system, and a signal from an auto-operation box AOB due to a obstacle of annex equipment (air conditioner, power supply unit, or the like) are monitored by a central monitoring center through respective public networks. Thus, once a obstacle occurs, the progress of recovery work made by a local maintainer and the result of the recovery work are reported to an operation manager by electronic mail or fax.

Further, JP-2000-148538 discloses a method aimed at efficient operation of personal computers. In this method, in order to improve the efficiency of analysis of obstacle sources generated in server systems, communication is made with analyzers by electronic mail correspondingly to kinds of faults, and sources of the faults and measures against the faults are stored in a public folder so that they can be browsed by ordinary users in the future. Thus, the method intends to increase the efficiency of the operation.

Judgment of obstacle places and judgment of obstacle sources are apt to depend on knowledge and experience of the monitoring person. In recent years, outsourcing of such monitoring service to an external agent is becoming popular. When an agent undertaking such outsourcing service acts for customers in monitoring or operating customer systems, the agent reports operating information to the customers, and performs monitoring of obstacle places and communication service.

Conventionally, as for measures taken when a obstacle occurs, by way of example, the customers usually hold the outsourcing agent responsible for measures against the obstacle. However, the outsourcing agent is busy with negotiation with vendors/makers of introduced apparatus while the vendors/makers are busily engaged in investigation into the source of the obstacle in the apparatus and recovery of the obstacle without knowing how the apparatus is used. Accordingly, there is a problem in view of both time and man-hour of work.

### SUMMARY OF THE INVENTION

Accordingly, an object of the present invention is to provide a cooperative outsourcing service method and system under a cooperative discussion environment in which design management information and operating information can be used for problem solution while operating information about a network system and server systems is disclosed to customers and designers at any time.

Another object of the present invention is to provide a cooperative outsourcing service method and system in which information about details of cooperative work made for problem solution whenever a obstacle occurs can be stored and utilized afterward, so as to be favorable to outsourcing service maintenance.

A further object of the present invention is to provide a service system architecture in which the operating information is accumulated continuously so that the customers, the hardware and software designers, the apparatus vendors/makers and the outsourcing agent can refer to the ex post facto operating information and the ex post facto discussion information at any time.

Incidentally, the operating information may be also called operation monitoring information because it is obtained as follows. A media information base MIB is obtained through packet internet groper PING using Internet control message protocol ICMP communication as interrupt Trap from the monitoring apparatus on the basis of SNMP whenever a obstacle occurs. Through the MIB, the operating conditions of a group of apparatus to be monitored are monitored, collected and accumulated continuously. That is, the operating information includes obstacle information indicating the portions where faults occurred, and the contents of the faults; network performance information indicating frequencies of data exchange and data transfer quantities in the network; server performance information indicating CPU utilization rates, and memory usage rates in the servers; and so on. Incidentally, ICMP is defined under RFC rules.

When the customers, the designers, and the operator share the operating information with one another, shortening of time for investigation into the source of a obstacle when the obstacle occurs, previous projection of timely upgrading of a group of hardware apparatus, and so on, can be performed smoothly. Thus, a new merit is provided for each of the customers, the apparatus makers, the apparatus vendors and the outsourcing agent.

Such an environment in which operating information can be shared and discussed together in order to solve problems is defined as “cooperative”. When the concept of the environment in which information can be shared and discussed is implemented, a new service architecture can be developed as a cooperative outsourcing service system in the outsourcing business.

The past experience (past similar obstacle phenomena, histories of measures against the obstacle phenomena, and histories of discussion) dealing with faults of interfaces among elemental technologies can be formed as documents in storage in addition to apparatus information, software information and design information about respective apparatus and software constructing the customer system, elemental technologies, and interfaces among the elemental technologies.

According to the present invention, there is provided a system for monitoring operation of a network system having: a center monitoring unit for collecting operation managing information from the network in which sites including a plurality of sites provided by different corporations are connected to one another; a design information storage having design information of the sites, the design information storage being connected to the center monitoring unit; an operating information storage having operating information of the sites, the operating information storage being connected to the center monitoring unit; a monitoring information storage storing obstacle information detected by the center monitoring unit from the operation managing information concerning any one of the sites; environment providing means for disclosing the design information, the operating information and the obstacle information to the different corporations; and a discussion history storage storing discussion information inputted by the different corporations.

Under the control of the center monitoring unit, the environment providing means extracts the obstacle information in the monitoring information storage and the discussion information in the discussion history storage correspondingly to a type of further obstacle information detected by the center monitoring unit. Thus, the environment providing means can disclose, to the different corporations, the extracted obstacle information and the extracted discussion information together with the design information, the operating information and the further obstacle information.

The system for operation monitoring may further have communication means connected to the center monitoring unit for communicating with the different corporations about the obstacle information.

The cooperative outsourcing service system according to the present invention is constituted by a monitoring unit on each customer side (hereinafter referred to as “site unit”), a centralized monitoring unit on the outsourcing agent side (hereinafter referred to as “center monitoring unit”), operation monitoring information storage means, operating information storage means, design and construction information storage means, communication means, cooperative problem solution environment means, and discussion history information storage means. The communication means is engaged in communication with the customers, system engineers SEs, hardware and software designers and apparatus vendors/makers. The cooperative problem solution environment means is engaged in solving problems cooperatively based on connection among apparatus.

When obstacle occurrence is detected by any one of site units, a processing program for sending obstacle information to the center monitoring unit is actuated to send notification of the obstacle occurrence and detailed obstacle information to the center monitoring unit. Further, when the center monitoring unit issues a request to send operation log information, the site unit sends performance monitoring data and obstacle monitoring data to the center monitoring unit in response to the request. Each site monitoring unit collects such performance monitoring data and obstacle monitoring data all the time.

A site unit is also installed in a server operation center undertaking service of monitoring the operation of a group of servers as outsourcing service. The site monitoring unit monitors and exchanges data with the center monitoring unit.

In the center monitoring unit, obstacle information sent from each site unit such as information about detection of obstacle occurrence and obstacle place is stored in an operation monitoring information file and an operation information file. If it is necessary to make a report to the customers, the center monitoring unit communicates with the customers via the communication means environment.

When electronic mail is used as an example of the communication means environment, mail addresses of the customers are obtained, and the obstacle information is sent by electronic mail. The operating information files, and design and construction information files are set to be browsable for the customers, the designers, the system engineers, and the operator at any time for the purpose of cooperative discussion. These files can be accessed via World Wide Web (WWW).

Further, discussion history information files include histories of discussion made by the customers, the designers, the system engineers, the operator, and further, if necessary, the apparatus vendors/makers. The discussion history information files can be referred to afterward via WWW. The contents of the design and construction information files and the discussion history files as well as the operating information files can be referred to via the Internet at any time in accordance with necessity.

In such a manner, the operator of the outsourcing service agent leaves work histories as memorandums correspondingly to the customers, and reports the work histories to the customers later as work behavior histories. The customers also leave dates, times and summaries of the reports from the operator as memorandums so as to run a check on the reported contents. Such a condition affords an effect that it is possible to avoid a state causing the lowering of reliability which may be generated in the future due to disagreement with the reported items.

Accordingly, by the cooperative outsourcing service system according to the present invention, the customers can refer to the operating information, the design and construction information, and the discussion history information at any time via the Internet. Whenever a obstacle occurs, not only the customers but also the designers, the system engineers and the operator can share the operating states and the design information accumulated till the obstacle occurred, and cooperate with one another to advance work for problem solution. Accordingly, a new service architecture can be developed.

Further, the operation monitoring data is accumulated continuously and formed into a database. In addition, various kinds of data analysis are made and data classification is made in accordance with the customers. Accordingly, a method for disclosing the operating information favorable for the customers is provided.

### BRIEF DESCRIPTION OF THE DRAWINGS

FIG. 1 is a diagram plainly showing the concept of a cooperative outsourcing service system according the present invention;

FIG. 2 is a diagram showing a representative overall view of hardware and software according to a specific mode for carrying out the cooperative outsourcing service system;

FIG. 3 is a diagram showing the relation between a DB management table DBMT for managing operation monitoring data stored in monitoring information files and operating information files correspondingly to customers and each customer operation data record UREC, and the relation between the DBMT and each design value data record CNFREC;

FIG. 4 is a diagram showing the relation between a discussion management table DISMT and each log record LOGREC when details of cooperative discussion are stored in discussion history information files;

FIG. 5 is a flow chart of the process when an MGR in a center monitoring unit collects operation monitoring data from AGTs in site units periodically;

FIG. 6 is a flow chart of the process associated with the supervisory manager when any one of the AGTs in the site units detects obstacle occurrence and reports it to the MGR in the center monitoring unit;

FIG. 7 is a flow chart of the process in which a sendmail function is actuated to send an electronic mail from the MGR in the center monitoring unit to the customers;

FIG. 8 is a flow chart of the process associated with a Web when the customers, system engineers, and designers, and further, if necessary, apparatus vendors/makers gain access to WWW via the Internet; and

FIG. 9 is a flow chart of the process when cooperative discussion work for problem solution is performed with reference to the operating information files and the design and construction information files.

### DETAILED DESCRIPTION OF THE EMBODIMENT

An embodiment according to the present invention will be described below in detail with reference to the drawings. Incidentally, description will be made here, by way of example, on the case in which an operation monitoring service is outsourced. The present invention can be carried out in various modes such as operation monitoring in one enterprise or in one group. It is, however, not necessary to limit the present invention to the configuration for outsourcing.

Further, the embodiment will be described on the case, by way of example, in which reception and transmission of electronic data are made by electronic mail on the Internet, as a communication means environment. The present invention can be carried out in modes such as on a LAN line, or by personal computer communication. It is not necessary to limit the present invention to the configuration on the Internet. The communication means environment may be formed by telephone communication or fax communication.

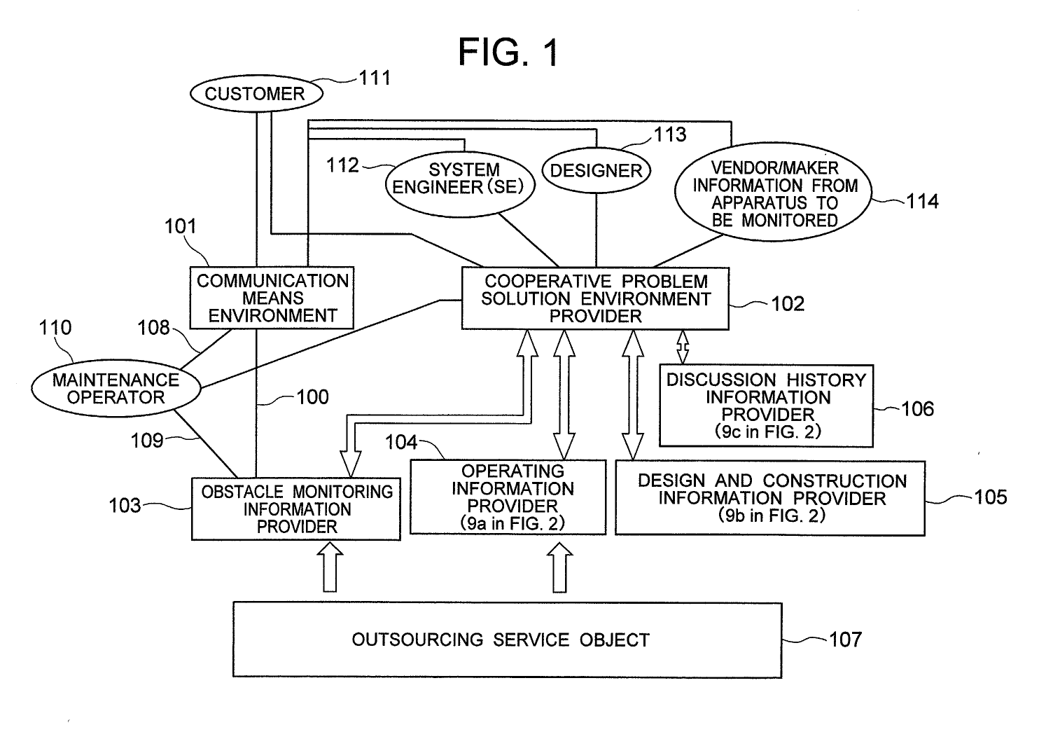

As shown in FIG. 1, the cooperative outsourcing service system according to the present invention is constituted by a communication means environment 101, cooperative problem solution environment providing means 102, obstacle monitoring information providing means 103, operating information providing means 104, design and construction information providing means 105, discussion history information providing means 106 and an outsourcing service object 107.

On the basis of the group of the abovementioned constitutive elements, a customer 111, a system engineer (SE) 112, a designer 113, and an apparatus vendor/maker 114 collaborate with one another, that is, cooperate with one another to proceed to work in order to solve problems. If necessary, the communication means environment 101 and the obstacle monitoring information providing means 103 are used instead of a line 100 so that a maintenance operator 110 can be involved in solving problem.

The result obtained by monitoring the outsourcing service object 107 is stored in the obstacle monitoring information providing means 103 all the time. When a obstacle occurs, the information providing means 103 communicates with the communication means environment 101 about a message of the obstacle occurrence. When the maintenance operator is involved, electronic mail is used to make communication with the customer 111 and the SE 112 about the obstacle information.

The operating information providing means 104 also has a function of storing operating information of the outsourcing service object 107 sequentially, and providing the operating information through WWW in response to a request to refer to the operating information. Here, the operating information providing means 104 stores obstacle information such as obstacle contents, performance information such as network traffic and server CPU utilization rate, and so on. Further, the design and construction information providing means 105 stores apparatus characteristics and set parameter values of each customer system and also has a function of providing the design and construction information via WWW in response to a request to refer to the apparatus characteristics and set parameter values of each customer system, in a manner similar to the operating information providing means 104.

When the obstacle source notified is clear, for example, when repair can be achieved by exchanging the apparatus into a new one, cooperative work using the cooperative problem solution environment providing means 102 may become unnecessary. On the other hand, there is a case that it takes much time for obstacle recovery, for example, it takes two or more hours to investigate the source. To say it more specifically, the obstacle may be judged to cause a phenomenon of extremely lowering data transferring capability with increase in the traffic volume on the network system, or the obstacle may be judged to be not recoverable even if the network apparatus is exchanged into a new one. In such a case, the cooperative problem solution environment providing means 102 is used so that the customer 111 and SE 112 start the cooperative work for recovering the obstacle. The cooperative problem solution environment providing means 102 provides knowhow such as histories of past obstacle phenomena and measures, histories of past discussion, and so on. Such knowhow is accumulated by each elemental technology supplier in association with interface technical elements among the technical elements of the customer system. Thus, time spent on investigation into the source can be shortened. If necessary, the designer 113, the apparatus maker 114 and the maintenance operator 110 can take part in the cooperative work. Who is responsible for operation for obstacle recovery depends on system design. Here, the designer 113 is a hardware apparatus designer, or a so-called software designer such as a processing program developer.

Information of discussion details during the cooperative work, specifically, details of the discussion contents or changes in the set parameters, discussion documents, or the like, can be stored in the discussion history information providing means 106 so as to be referred to afterward.

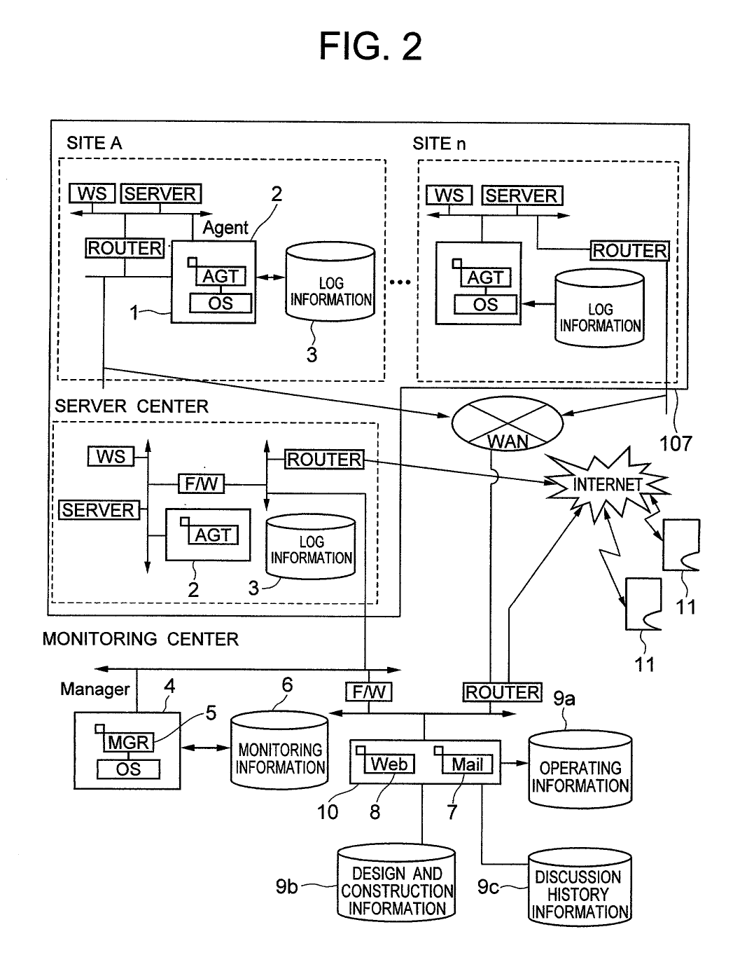

Next, with reference to FIG. 2, a representative overall view of a cooperative outsourcing service system will be described.

The main portion of the outsourcing service system according to the present invention includes a center monitor 4 and a cooperative work environment providing server 10. The cooperative work environment providing server 10 is a server implementing the communication means environment 103 and the cooperative problem solution environment providing means 102 in FIG. 1. Further, a site A, a site n and a server center in FIG. 2 correspond to the outsourcing service object 107 in FIG. 1.

The center monitor 4 and a plurality of sites 1 are connected to each other via Wide Area Network WAN. The WAN may be a public circuit or a leased circuit. Further, the center monitor 4 can communicate with the sites 1. In the embodiment of FIG. 2, the center monitor 4 also communicates with an agent AGT 2 in the server center. Agents AGTs 2 in the sites 1 and a manager MGR 5 in the center monitor 4 operate under operating systems OS respectively.

The customer 111, the SE 112, the designer 113, and the vendor/maker 114 in charge can access the cooperative problem solution environment providing means 102 respectively by use of client terminals 11 connected to the Internet. Here, the terminals 11 may be personal computers PCs, workstations WSs, or portable terminals. Incidentally, in FIG. 2 et seq. shown for the embodiment, constituent members having the same function will be referenced correspondingly.

First, operation when one of the agents AGTs 2 detects occurrence of a obstacle will be described. The AGT 2 monitors the state of a group of pieces of apparatus to be monitored on the basis of the operating rules of SNMP. The group of pieces of apparatus to be monitored include routers, servers, workstations, and the like. The result of the monitoring status is stored in a corresponding log information file 3 sequentially. When occurrence of a obstacle in the group of pieces of apparatus is detected, a obstacle notification interrupt Trap is issued to the supervisory manager MGR 5 in the center monitor 4 so that the obstacle information is sent, as a media information base MIB, to the MGR 5. The process flow associated with the MGR 5 at the time of obstacle occurrence will be described later in FIG. 6.

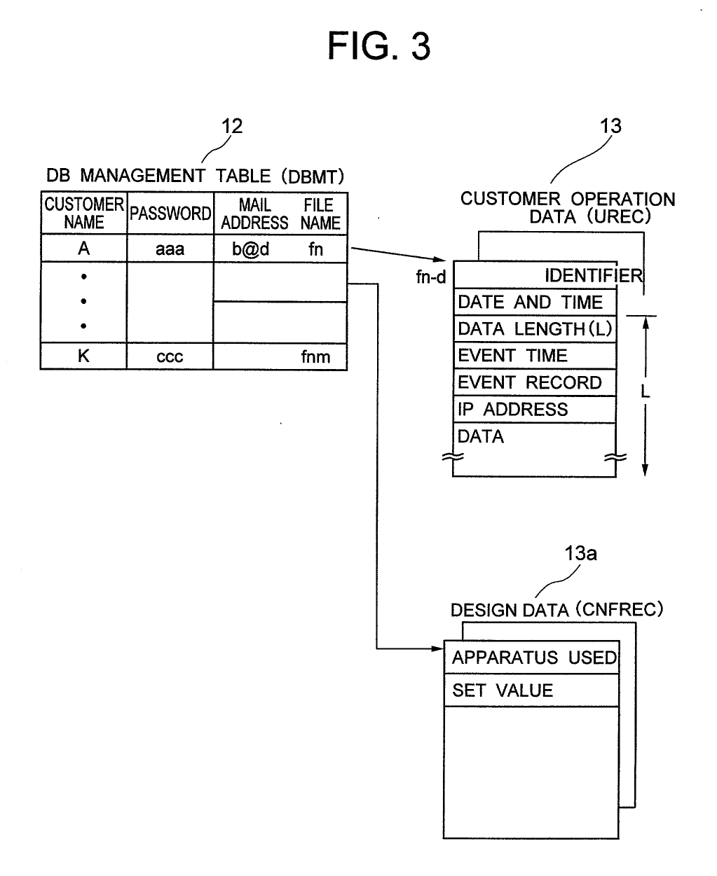

FIG. 3 shows the relation between a DB management table DBMT 12 managed by the manager MGR 5 and a customer operation data record UREC 13, and the relation between the DBMT 12 and a design data record CNFREC 13a when the design information is stored in a design and construction information file 9b. These management tables are stored in a monitoring information file 6, an operating information file 9a and the design and construction information file 9b. Further, when the OS is actuated, these management tables are loaded into main memories (not shown) of the center monitor 4 and the cooperative work environment providing server 10 which are installed in the monitor center.

The cooperative work environment providing server 10 is a server implementing the cooperative problem solution providing means 102, the operation information providing means 104, the design and construction information providing means 105 and the discussion history information providing means 106 in FIG. 1. However, each of these means may be achieved by a separate server individually.

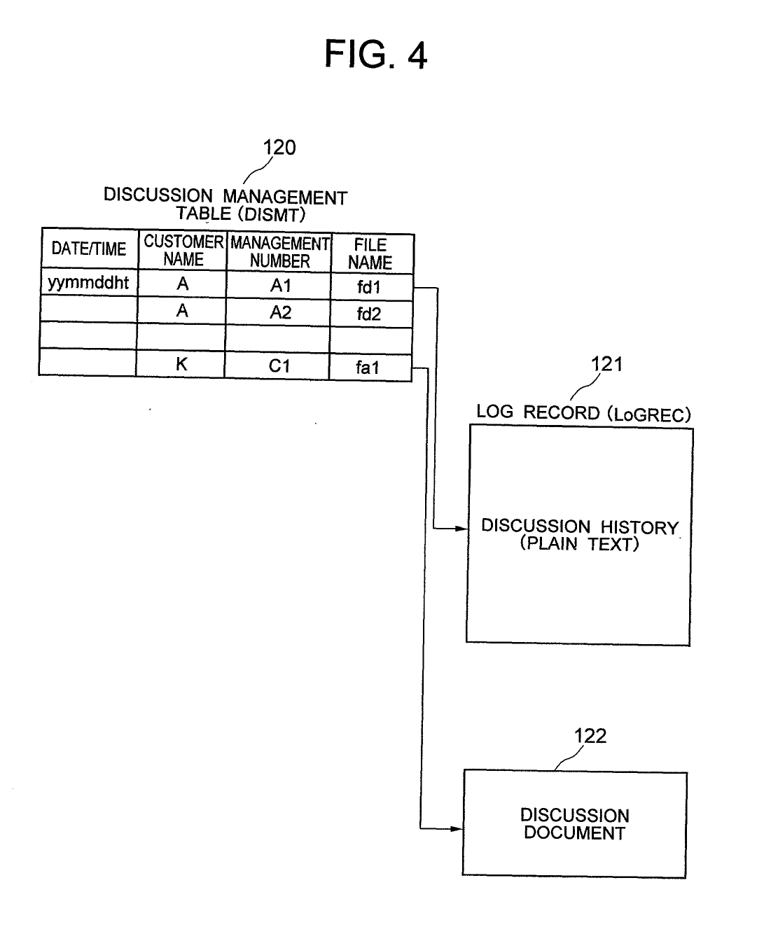

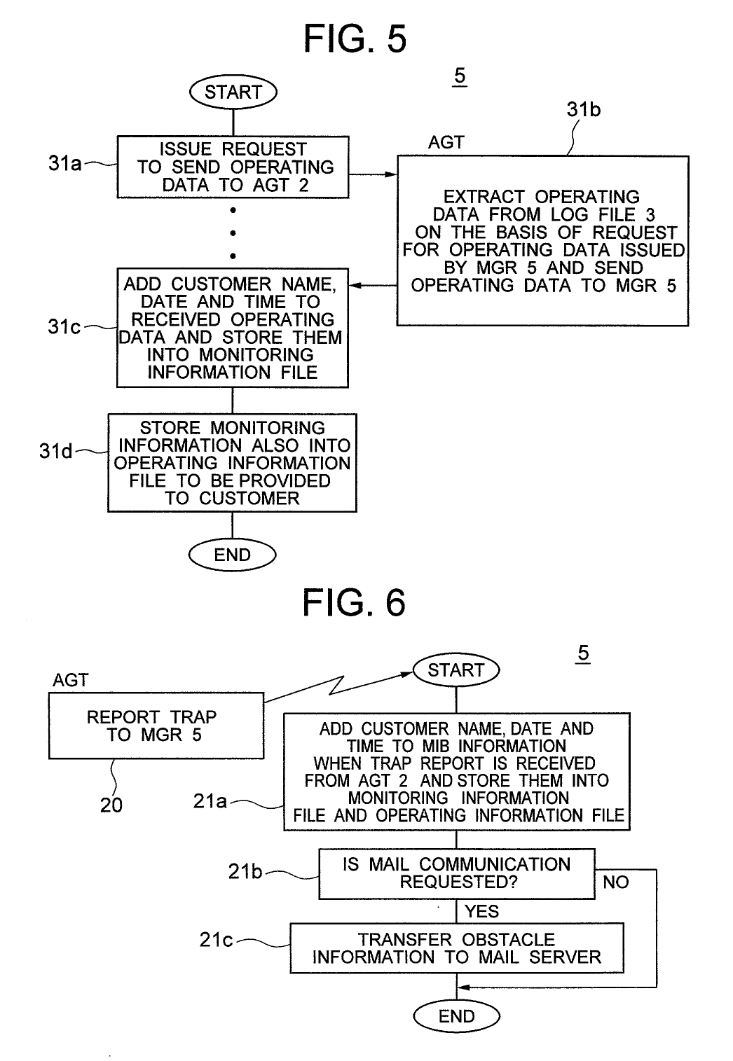

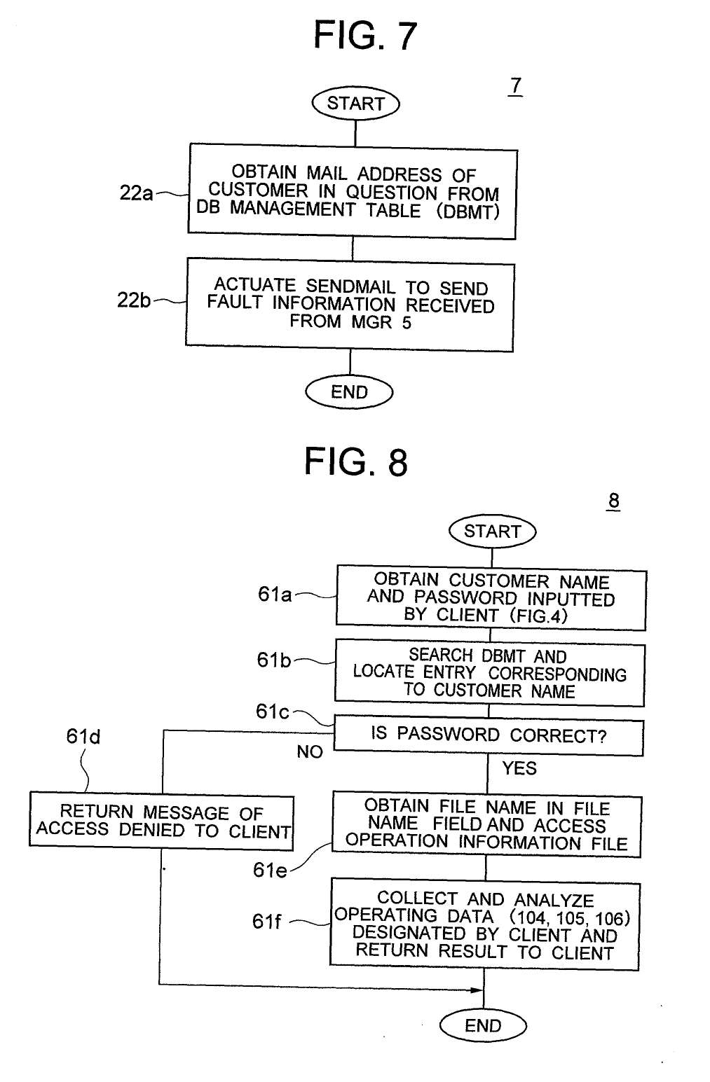

FIG. 4 shows the relation between a discussion management table DISMT 120 and a log record LOGREC 121 for managing the discussion history file 9c implementing the recording means portion of the discussion history information providing means 106 in FIG. 1. When the OS is actuated, copies of the discussion management table DISMT 120 and log record LOGREC 121 are created in the main memory (not shown) of the cooperative work environment providing server 10 installed in the monitor center. The log record 121 includes mail communication records and the like discussed among the designer, the SE, and the vendor/maker for the purpose of obstacle recovery. The log record 121 can be used as a history useful for future obstacle recovery. A discussion document 122 is data required for the discussion.

In FIG. 6, when any one of the AGTs 2 in the sites to be monitored, that is, the site A, the site n and the server center sends a Trap report of obstacle occurrence to the MGR 5 by the processing step 20, the MGR 5 executes a processing step 21a to a processing step 21c. In the processing step 21a, in addition to the MIB information sent from the AGT 2, the customer name and the date and time are added to the UREC 13 so as to form the UREC 13 in FIG. 3, and the UREC 13 formed thus is stored in the monitoring information file 6 and the operating information file 9a. The UREC 13 is stored for every customer in accordance with the management information of the DBMT 12 in FIG. 3.

In a decision processing step 21b, decision whether to communicate by electronic mail is made in accordance with kinds of faults and customer names. For the customer who requests communication by electronic mail, processing in the processing step 21c is executed in a Mail 7 shown in FIG. 2. This communication process by electronic mail becomes the communication means environment 101 in FIG. 1. Customers are asked in advance whether they request communication by electronic mail or not. For example, flag data are further provided as well as mail addresses in the DBMT 12. Thus, the decision whether to communicate by electronic mail may be made with reference to the flag data.

Incidentally, when communication is made with the customer, setting can be made so that telephone communication or electronic mail communication is also made with the SE 112 in charge from the communication means 101 in parallel with the communication with the customer in accordance with necessity. Communication with anyone other than the customer may be made only if the obstacle source cannot be specified and it is hence estimated that it takes much time for obstacle recovery. The extent to be defined as much time may be set suitably from the past obstacle recovery cases. Further, when the customer has an agreement that the customer always requests communication with the SE in charge, communication with the SE in charge may be set to be essential. Communication with the designer and the apparatus vendor is decided by the SE.

Alternatively, faults which need communication with the designer and the apparatus vendor may be set in advance from the past obstacle recovery cases. In such a case, the communication can be made by electronic mail or telephone from the maintenance operator 110 or the SE 112.

FIG. 7 shows a process flow in the mail processing portion (Mail) 7. When communication with the customer is to be made by electronic mail, the mail address of the customer is obtained, in a processing step 22a, from a field corresponding to the customer in the DBMT 12 in FIG. 3 so that a mail message form and a mail address form for the Internet mail are created in accordance with the RFC 821 rule.

Next, in order to send the message of the electronic mail to the Internet mail, the mail text is sent to a sendmail function mounted in the Mail 7 in a processing step 22b. For example, in the processing process of the sendmail function of UNIX (OS developed by Bell Laboratories of AT&T Corp. in the U.S., under the trade mark of “The Open Group”), the mail text is sent to the mail server of the domain designated by the mail address of the customer via the Internet so as to send notification of obstacle occurrence to the customer.

As described above, as soon as notification of obstacle occurrence is sent to the customer, the notification is also sent to the SE in charge. On this occasion, while the maintenance operator 110 endeavors to recover the obstacle, the SE 112 receiving the notification of obstacle occurrence is also involved in the obstacle recovery. In the case of the embodiment, the vendor/maker 114 means the supplier of the system per se, that is, the hardware (apparatus), and provides its own instruction manual and support for use of the apparatus. The designer 113 designs middleware and system software matched to the specifications of such hardware. The designer 113 also provides its own instruction manual and support for use of the middleware and the like. Further, the SE 112 provides a final system desired by the customer 111 as a combination of the apparatus made by the vendor/maker 114 with the software created by the designer 113 (system integration). In addition, the maintenance operator 110 exists for managing the final system.

In such a relation, once a obstacle occurs in the operation of the final system, the maintenance operator 110 is busy with recovering of the final system from the obstacle. This busyness is caused for the following reason. That is, the vendor/maker 114 premises that the supplied apparatus is used within the extent defined in the instruction manual. Thus, if the vendor/maker 114 considers the apparatus to be used on such a premise, the vendor/maker 114 may consider that the final system cannot be recovered from the obstacle by repairing the apparatus itself. Similarly, the designer 113 assumes that the SE 112 constructs the system within the extent of the specifications of middleware and the like. Thus, the designer 113 may often consider that the designer 113 cannot contribute to the obstacle recovery of the final system.

However, even if apparatus, software and system construction are all complete, there may occur inconsiderable use modes of the end user, contingencies, or affairs which could not be considered when the apparatus and the software were designed. Thus, even if the system is in use in accordance with the specifications, troubles may still happen. On such an occasion, the SE 112, the designer 113, and the vendor/maker 114 can refer to the operation mode of the final system so as to find bottleneck portions in the respective apparatus and software supplied by themselves. Therefore, the SE 112, the designer 113, and the vendor/maker 114 can put these bottleneck portions to good use for future apparatus and software to thereby provide better products and service.

The cooperative problem solution environment providing means 102 described in this embodiment provides an environment, under which information can be shared, to a corporation or the like who operates a final product obtained as a combination of products and service generally provided by different organizations, different corporations, different corporations, different companies (groups and the like).

Particularly, not only is information about the state of a obstacle in the final system, the recovery of the past obstacle cases and so on provided, but also the operating information at the time of normal operation before the occurrence of the obstacle is provided.

As will be described later, the customer can access the operating information at any time by use of the password registered in advance. For example, the SE 112, the designer 113 and so on also may receive notification of a obstacle when the obstacle occurs. In such a case, the server 10 providing the cooperative problem solution environment may give the SE 112, the designer 113 and so on the same access authority as the access authority with which to the customer 111 can access the contents of the operating information file 9a provided by the Web 8 in the cooperative work environment providing server 10, or conditional access authority. Specifically, the password of the customer in the DBMT 12 may be sent also to the SE 112 as soon as notification of the obstacle occurrence is sent to the customer 111. Alternatively, some kind of password in which the password of the customer has been encrypted or processed so that a part of information can be referred to may be sent to the SE 112 likewise.

Thus, access to the cooperative problem solution environment made by the corporation, and so on, as the suppliers of the apparatus and software results in finding faults or operation failures occurring in the state which could not be presumed when the products was shipped. Accordingly, improvement of the elemental apparatus or software constructing the final system is urged so that the performance of the final system can be improved.

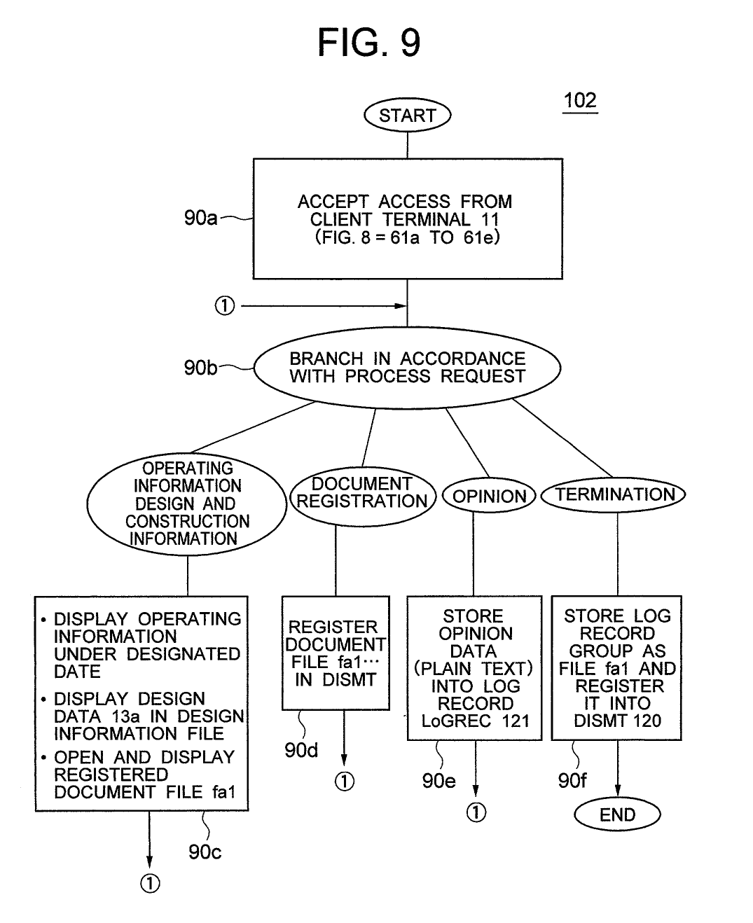

Description will be made on a processing operation improved in the convenience when the operating information is provided to the customer. This processing is executed by the MGR 5 and the Web 8 in the cooperative work environment providing server 10 in FIG. 2, and FIGS. 5 and 8 show process flows for the MGR 5 and the Web 8 respectively.

In FIG. 5, in a processing step 31a, the supervisory manager unit MGR 5 requests the monitor agent units AGTs 2 to send the operation monitoring data periodically, for example, every one hour. The AGTs 2 send the operation monitoring data stored in the log files 3 to the MGR 5 in a processing step 31b. Each of the log files 3 includes a traffic volume of the network, a CPU utilization rate of the corresponding server, performance monitoring data such as a memory usage rate, obstacle monitoring data, and so on.

In processing steps 31c and 31d, the MGR 5 stores the operation monitoring data received from the AGTs 2 in the monitoring information file 6 and the operating information file 9a. Accordingly, when the customer gains access to the operating information for reference via the Internet, the Web 8 in the cooperative work environment providing server 10 achieving the operating information providing means 104 provides the contents of the operating information file 9a correspondingly to the customer.

FIG. 8 is the process flow in the processing portion (Web) 8 described in FIG. 2. In a processing step 61a, a password of a user inputted through one of the client terminals 11 shown in FIG. 2 is obtained. Next, in processing steps 61b and 61c, the DBMT 12 shown in FIG. 3 is searched to find out an entry corresponding to the client terminal. Thus, the password is checked in comparison with the information of a password field stored correspondingly to the customer name.

As a result of the password check, when the password inputted through the client terminal 11 by the user turns out to be different from the information of password field stored in the DBMT 12, a message indicating this result is sent to the user in a processing step 61d and the routine of the process is terminated. On the other hand, when the password inputted by the user agrees with the information of password field stored in the DBMT 12 and reference to the operating information is allowed, the operating information corresponding to the customer is provided. This process is executed in processing steps 61e and 61f. In the processing step 61e, the file name of the customer is obtained from the DBMT 12 in FIG. 3, and the operating information file 9a is located. Incidentally, such a password may be assigned in advance not only to the customer 111 but also to the corporation and so on involved in the final system so that the operating information is provided and shared with the corporation and so on. At that time, in the DBMT 12, a password may be set for the corporation and so on. In addition, setting may be done so that the shared information which can be referred to with the password is restricted.

Next, in the processing step 61f, on the basis of an analyzing request designated by the client terminal 11, the operation monitoring data is processed in accordance with the analyzing instruction made by the client terminal 11. Accordingly, the analytical result can be referred to by the client terminal 11.

As analyzing examples, numbers of faults can be classified in accordance with occurrence point, source, occurrence (recovery) time, down time, phenomenon, obstacle place, measure content, and so on. Further, time series transition of these faults, a constitutive ratio of these faults to the total, comparison in accordance with occurrence point, source, and so on can be also referred to.

The following example can be considered as an analyzing example. When the MGR 5 receives a traffic volume of the network as the operating data from each log information file 3 and the traffic volume is stored as the monitoring information in the monitoring information file 6 and the operating information file 9a, a customer operation data record is collected from the user. In the middle of the collecting processing by the Web 8, the user is made to choose in advance the data that the user wants to know, for example, in accordance with the classifications “1. current traffic volume of the network”, “2. traffic volume of the network in the past XX hours”, and “3. transition of traffic volume of the network (every one hour, every 24 hours, or the like)”. If the user has another request on the data form, the operating data is provided in the form satisfying the request. In each of the abovementioned classifications, sub-classifications may be contained such as “data classified by portion”. In response to the request issued by such a user, the Web 8 processes or statistically works the collected customer data record and transmits it to the user (the client).

Further, as another example, when performance monitoring data such as the memory usage rate (the performance monitoring data is also included in the operation monitoring data according to the present invention) are sent from one of the AGTs 2 to the MGR 5, the Web 8 can process the data into the following data so as to provide the processed data to the user. For example, when the user issues a request, a free area per ser of a logical drive available to the user is displayed, or the transition thereof is displayed on a time basis. Alternatively, the transition thereof on a day basis is statistically processed and displayed, or the use state of each unit (for example, every portion) on the user side is displayed. Further, instead of the logical drive, rest capacity of a virtual memory may be displayed in a graph. Similarly, data about the CPU utilization rate of each server may be processed and displayed.

Thus, when the processed data in the requested form is provided to the user in response to the request issued by the user, abnormal operation of the system, system down, and performance degradation can be recognized easily on the user side in spite of outsourcing. Thus, unreasonable operation can be avoided, so as to contribute to improvement in the system environment and the degree of satisfaction of the user per se, and accordingly, so as to contribute to improvement in performance of the whole system which is shared with other users.

Besides, examples of analysis of the performance monitoring data stored in the operating information file 9a may include analysis by point, time series transition of the CPU utilization rate, and so on.

FIG. 9 shows a flow chart of the process executed when cooperative discussion work for problem solution is done while the operating information file 9a and the design and construction information file 9b are referred to. The process in FIG. 9 is the process in the cooperative problem solution environment providing means 102. The process of storage into the discussion history information file will be also described.

More specifically, WWW interface is provided to the client terminals 11 by the cooperative work environment providing server 10 in FIG. 2. In a processing step 90a, processing similar to that in the processing steps 61a to 61e in FIG. 8 is executed. The next processing step 90b branches in accordance with the kind of access request from each of the client terminals 11, so that any one of the processing steps 90c to 90f is executed.

(a) Reference to Operating Information, Design and Construction Information, and Document

When the processing step 90c is executed, a file corresponding to a request of any one of the client terminals 11 is opened and displayed in the WWW interface.

(b) Document Registration

When the processing step 90d is executed, a file name “fa1” of a document is registered in the discussion management table DISMT 120 in FIG. 4.

(c) Opinion Registration

When the processing step 90e is executed, the log record LOGREC 121 is created sequentially. The form of the text at this time is set in a plain text form and no special software for access is needed.

(d) Termination

When the processing step 90f is executed, a group of log records are registered as a file given a file name “fd1”.

According to the above description, discussion details can be also referred to afterward. In addition, instructions to the maintenance operator or instructions to the SE, and the discussion document 122 and the history of the discussion details (discussion history 121) among the designer, the constructor, and the apparatus vendor/maker can be referred to by all the participants including the customer, and contents of faults and states of measures against the faults can be shared too.

As described above, according to the present invention, when a obstacle occurs in the process in which the service for monitoring operation of the customer system is performing, the customer, the maintenance operator, the SE, the designer, and the apparatus vendor/maker can share the common information to solve a problem. Accordingly, it brings a merit to all the posts involved, so that a new outsourcing service architecture can be created.

Further, when the customer receives a report of the monitoring result of the customer system or the result of surrogate operation of a group of servers of the customer system by the server operation center, the customer can refer to the result at any time when the customer needs the result, in stead of simply being submitted a report as paper regularly or after the measures against the obstacle are taken. In addition, timely communication can be achieved by use of electronic mail. Accordingly, there is an effect that convenience for the customer, efficiency of outsourcing service, and quality of the operation can be improved.

Further, the customer can refer to various analytical results of operation monitoring data. Thus, the customer can carry out operation and management of a network or a server operating system up to introduction and expansion thereof deliberately and reasonably.

It will be further understood by those skilled in the art that the foregoing description has been made on an embodiment of the invention and that various changes and modifications may be made in the invention without departing from the spirit and scope of the appended claims.

What is claimed is:

1. A system for monitoring operation of a network system comprising:
a center monitoring unit for collecting operation managing information from a network in which sites including a plurality of sites provided by different corporations are connected to one another;
a design information storage having design information of said sites, said design information storage being connected to said center monitoring unit;
an operating information storage having operating information of said sites, said operating information storage being connected to said center monitoring unit;
a monitoring information storage storing obstacle information detected by said center monitoring unit from said operation managing information concerning any one of said sites;
environment providing means for disclosing said design information, said operating information and said obstacle information to said different corporations; and
a discussion history storage storing discussion information inputted by said different corporations.

2. A system for operation monitoring according to claim 1, wherein under control of said center monitoring unit, said environment providing means extracts said obstacle information in said monitoring information storage and said discussion information in said discussion history storage correspondingly to a type of further obstacle information detected by said center monitoring unit, and discloses, to said different corporations, said extracted obstacle information and said extracted discussion information together with said design information, said operating information and said further obstacle information.

3. A system for operation monitoring according to claim 1, further comprising:
communication means connected to said center monitoring unit for communicating with said different corporations about said obstacle information.

4. A system for operation monitoring according to claim 3, wherein said communication means includes at least one of electronic mail, telephone and fax.

5. A program for operation monitoring which is read and run by a system for monitoring operation of a network system, comprising the steps of:
collecting operation managing information from a network in which sites including a plurality of sites provided by different corporations are connected to one another;
storing operating information of said sites in an operating information storage under control of a center monitoring unit;
storing, in a monitoring information storage, obstacle information detected by said center monitoring unit from said operation managing information concerning any one of said sites;
disclosing design information, said operating information and said obstacle information to said different corporations; and
storing, in a discussion history storage, discussion information inputted by said different corporations.

6. A program for operation monitoring according to claim 5, further comprising the step of:
under control of said center monitoring unit, extracting said obstacle information in said monitoring information storage and said discussion information in said discussion history storage correspondingly to a type of further obstacle information detected by said center monitoring unit, and disclosing said extracted obstacle information and said extracted discussion information together with said design information, said operating information and said further obstacle information to said different corporations from environment providing means.

7. A program for operation monitoring according to claim 5, further comprising the communication step of:
communicating with said different corporations about said obstacle information under control of said center monitoring unit.

8. A program for operation monitoring according to claim 7, wherein said communication step includes a step of performing transmission by at least one of electronic mail, telephone and fax.

9. A program for operation monitoring according to claim 5, further comprising the step of:
permitting a user to gain access to said environment providing means under control of said center monitoring unit when said user is permitted to make reference in accordance with a type of a obstacle.

10. A method for providing a service architecture of monitoring operation of a network system and operating servers in an operation managing system, said operation managing system including a center monitoring unit for monitoring a plurality of sites on a network, operation monitoring information storage means for storing operating information for every service object, operating information storage means for storing operating information extracted from said operation monitoring information storage means correspondingly to a customer, design and construction information storage means for storing design and construction information of a customer system, communication means environment means, cooperative problem solution environment means and discussion history information storage means, said method comprising the steps of:
(a) storing operation managing information collected and detected by said center monitoring unit in said operation monitoring information storage means, and in parallel therewith, storing said operation managing information in said operating information storage means correspondingly to a customer;
(b) giving a message of obstacle occurrence via said communication means environment means when obstacle information is detected by said center monitoring unit;
(c) outputting information about obstacle source with reference to said operating information storage means and said design and construction information storage means in response to access to said cooperative problem solution environment means; and
(d) sequentially storing a document of discussion process and discussion details in said discussion history information storage means.

11. A method according to claim 10 wherein a communication means environment uses electronic mail, telephone or fax as a medium.

12. A method according to claim 10, further comprising the step of:
storing said operating information or said design and construction information in a world wide web server in a cooperative problem solution environment, and providing said operating information or said design and construction information via the Internet only when a user permitted to make reference gains access to said cooperative problem solution environment.

13. A method according to claim 10, further comprising the step of:
storing said document or discussion details used for cooperative problem solution as discussion history information in said cooperative problem solution environment.

14. A method according to claim 10, further comprising the steps of:
storing said document or discussion details used for cooperative problem solution as discussion history information in said cooperative problem solution environment; and
referring to said registered discussion history information afterward.

15. A method for recovering a obstacle in an outsourcing service system comprising the steps of:
notifying a plurality of corporations having no capital relation with one another, of occurrence of a obstacle when said obstacle occurs in apparatus provided by said corporations; and
permitting said corporations to refer to an operation state of said system immediately before said obstacle occurrence.

16. A method according to claim 15, wherein said permission step includes a step of transmitting a password for referring to data of said operation state to said corporations.

17. A storage medium comprising:
an operation monitoring program read and run by a system for monitoring operation of a network system;
said program including the steps of:
collecting operation managing information from a network in which sites including a plurality of sites provided by different corporations are connected to one another;
storing operating information of said sites in an operating information storage under control of a center monitoring unit;
storing, in a monitoring information storage, obstacle information detected by said center monitoring unit from said operation managing information concerning any one of said sites;
disclosing design information, said operating information and said obstacle information to said different corporations; and
storing, in a discussion history storage, discussion information inputted by said different corporations.

18. A storage medium according to claim 17, wherein said program includes the step of, under control of said center monitoring unit, extracting said obstacle information in said monitoring information storage and said discussion information in said discussion history storage correspondingly to a type of further obstacle information detected by said center monitoring unit, and disclosing said extracted obstacle information and said extracted discussion information together with said design information, said operating information and said further obstacle information to said different corporations from environment providing means.

19. A storage medium according to claim 17, wherein said program includes the communication step of communicating with said different corporations about said obstacle information under control of said center monitoring unit.

20. A storage medium according to claim 19, wherein said communication step includes a step of performing transmission by at least one of electronic mail, telephone and fax.

21. A storage medium according to claim 17, wherein said program includes the step of permitting a user to gain access to said environment providing means under control of said center monitoring unit, when said user is permitted to make reference in accordance with a type of a obstacle.
